(19) United States
(12) Patent Application Publication
(10) Pub. No.: US 2003/0094740 A1
(43) Pub. Date: May 22, 2003

(54) Air-spring system

(76) Inventor: Michael Weber, Buchholz (DE)

Correspondence Address: WILLIAM COLLARD, COLLARD & ROE, P.C., 1077 NORTHERN BOULEVARD, ROSLYN, NY, 11576, US

(21) Appl. No.: 10/311,719

(22) PCT Filed: Apr. 5, 2002
(86) PCT No.: PCT/DE02/01241

(30) Foreign Application Priority Data
Apr. 20, 2001 (DE) 101 19 674.1

(51) Int. Cl. F16F 5/00

(52) U.S. Cl. 267/64.11; 267/122

(57) ABSTRACT

The invention relates to an air-spring system at least comprised of: air-spring bellows (3), which are made of an elastomeric material with two bellows ends and which enclose a volume-elastic air chamber while forming a loop, and which are particularly provided with an outer guide (5); a cover (2) and plunger with a connection area (10) for each bellows end, whereby the plunger has a roll-off surface for the loop, and; a sleeve (6), which is provided with a first retaining collar (8) that, together with the corresponding bellows end (11), is fastened to the cover (2) by means of a clamping ring (7), and which has a second retaining sleeve (12) that is anchored at least inside the static area of the air-spring bellows (3) and/or on the outer guide (5). The inventive air-spring system is characterized in that at least one recess (9) is provided inside the first retaining collar (8) of the sleeve (6). This recess permits an unobstructed view of the corresponding bellows end (11) from the exterior and, to be precise, of the seized state.

The invention relates to an air spring system at least comprised of the following:

An air spring bellows made of an elastomeric material and having two ends of the bellows, which encloses an air chamber with a flexible volume, forming a loop, and which is in particular provided with an outer guide;

a cover and a plunger each with a connection area for the respective end of the bellow, whereby the plunger has a roll-off surface for the loop; as well as

a sleeve with a first retaining collar, which is fastened on the cover jointly with the corresponding end of the bellows by means of a clamping ring, and a second retaining collar, which is anchored in most cases within the static area of the air spring bellows and/or the outer guide.

An air spring system of this type is widely used in motor vehicle building (passenger cars, utility and rail-borne vehicles), whereby reference is made particularly to the published patent documents DE 298 23 508 U1; DE 100 50 028 A1 and 101 06 064 A1. These publications primarily introduce the technology of the air spring bellows with an external guide.

According to utility model DE 298 23 508 U1, the outer guide is tied to the cover. The outer guide is expected to permit a greater Cardan deflection by means of a sleeve as well. The first retaining collar is in this connection arranged between a clamping ring and an additional clamp. Such a tying concept requires considerable expenditure and it is cost-intensive. Most of all, the positioning of the clamping ring requires considerable expenditure.

It has therefore been proposed in laid-open patent document DE 101 06 064 A1 to arrange the first retaining collar of the sleeve between the corresponding end of the bellows and the clamping ring. In this way, the air spring bellows is thickened (reinforced) within the clamping area, which is advantageous in view of its useful life.

The sleeve may additionally have a protective function. Furthermore, it is possible to use the sleeve as a supporting bearing for a second loop (DE 101 06 064 A1).

Now, the problem of the invention within the framework of a further development is to design the sleeve in such a manner that the position of the bellows within the clamping area can be checked at a later time.

This problem is resolved according to the characterizing part of claim 1 in that at least one recess is present within the first retaining collar of the sleeve, such a recess permitting an unobstructed view of the corresponding end of the bellows, namely with respect to the clamped condition.

Useful further developments of the invention are specified in claims 2 to 4.

The invention is explained in the following with the help of an exemplified embodiment and by reference to schematic drawings, in which:

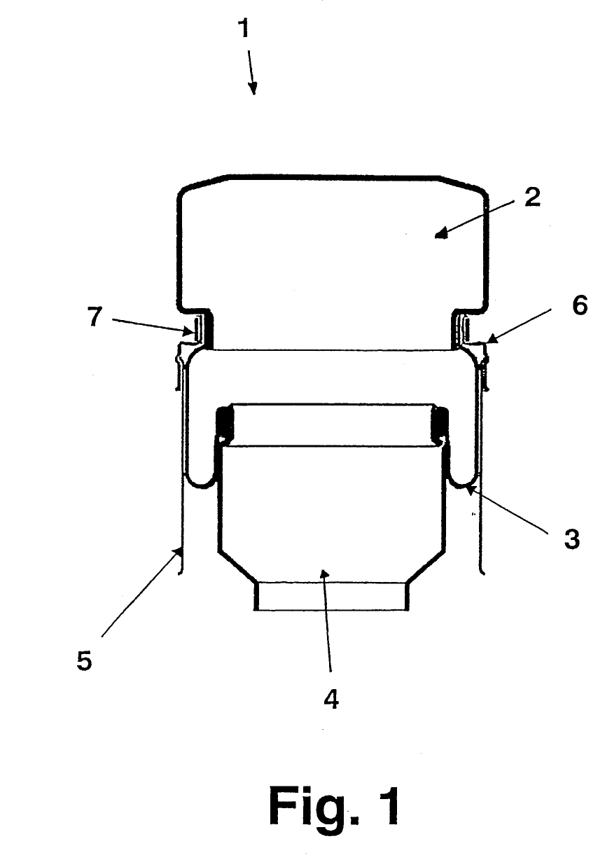

FIG. 1 shows an air spring system with the basic structural components of the construction.

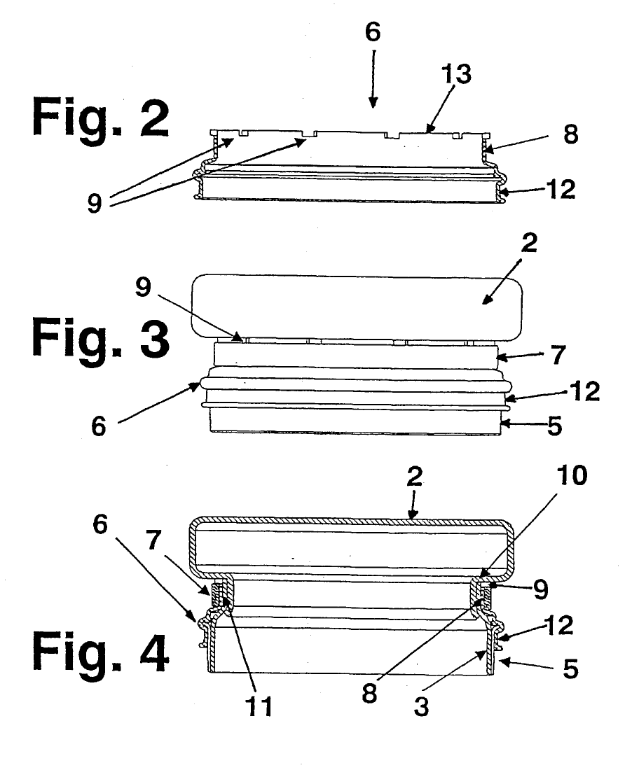

FIG. 2 shows a sleeve with recesses.

FIG. 3 shows a side view of the air spring system with an installed sleeve according to FIG. 2; and

FIG. 4 shows a sectional view of the air spring system according to FIG. 3.

FIG. 1 shows an air spring system 1 with the important basic components of the construction, namely the air spring bellows 3, the cover 2 with possibilities for the tie-up to the body; the plunger 4 and the sleeve 6. The cover may be signed in the form of a pressure container in connection with a valve, if need be (DE 198 19 642 A1).

In most cases, the air spring bellows 3 is provided with an embedded reinforcement in the form of an axial bellows (DE 36 43 073 A1) or a bellows with crossed layers (DE 29 04 522 A1). The two ends of the bellows are fastened within the two connection areas on the cover 2 and the plunger 4, respectively. An air chamber with an elastic volume is formed in this way. When contracting, a loop (=the dynamic area of the air spring bellows) is formed, which is capable of sliding along the roll-off surface of the plunger 4. An additional outer guide 5 supports the air spring bellows, which is important especially when an axial bellows is used.

Now, FIG. 2 shows details of the sleeve 6 which, in the exemplified embodiment according to FIG. 1, is particularly used as a protective sleeve and consists of an elastomeric material, a thermoplastic elastomer (TPE), a thermoplastic material or a textile material. The sleeve comprises in this connection a first retaining collar 8 and a second retaining collar 12, which each are flanged outwards at their ends. Now, several recesses 9 are present within the outer edge 13 of the first retaining collar. These recesses are arranged with about the same spacing between each other.

FIGS. 3 and 4 illustrate the cooperation between the cover 2, the air spring bellows 3, the outer guide 5 and the sleeve 6. Accordingly, the first retaining collar 8 and the corresponding end 11 of the bellows are jointly fastened on the cover 2 within the connection area 10 by means of a clamping ring 7. By means of the recesses 9 it is possible to check the position of the air spring bellows 3 even when it is in a seized state.

The second retaining collar 12 tightly grips around the outer guide 5 in a fixed manner, whereby it is fastened by means of gluing and/or a clamping ring. If the air spring system has no outer guide, the second retaining collar is anchored within the static area of the air spring bellows. If necessary, the second retaining collar may be designed in such a manner that it assumes at the same time the function of the outer guide (DE 2 064 751 A1, FIG. 2).

### List of Reference Numerals

1 Air spring system

2 Cover (pressure container)

3 Air spring bellows with loop (rolling pleat)

4 Plunger (roll-off plunger, immersing plunger)

5 Outer guide

6 Sleeve

7 Clamping ring

8 First retaining collar of the sleeve

9 Recesses

10 Connection are (clamping seat) of the cover

11 End of bellows

12 Second retaining collar of the sleeve

13 Outer edge of the first retaining collar

1. An air spring system at least comprised of:
An air spring bellows (3) made of elastomeric material with two ends of the bellows encompassing an air chamber with an elastic volume, forming a loop, and in particular provided with an outer guide (5);
a cover (2) and a plunger (4) each with a connection area (10) for the respective end of the bellows, whereby the plunger has a roll-off surface for the loop; as well as
a sleeve (6) with a first retaining collar (8) fastened on the cover (2) jointly with the corresponding end (11) of the bellows by means of a clamping ring (7), and a second retaining collar (12) anchored in most cases within the static area of the air spring bellows (3) and/or on the outer guide (5),
characterized in that
at least one recess (9) is present within the first retaining collar (8) of the sleeve (6), such recess permitting an unobstructed view of the corresponding end (11) of the bellows namely with respect to the seized state.

2. The air spring system according to claim 1, characterized in that several recesses (9) extending all around are present.

3. The air spring system according to claim 2, characterized in that the recesses (9) are arranged with about the same spacing between one another.

4. The air spring system according to any one of claims 1 to 3, characterized in that the recess or recesses (9) is/are arranged within the outer edge (13) of the first retaining collar (8).
